(19) United States
(12) Patent Application Publication
(10) Pub. No.: US 2012/0152988 A1
(43) Pub. Date: Jun. 21, 2012

(54) Standing Child Carrier

(76) Inventor: Robert William Green, III, Sicklerville, NJ (US)

(21) Appl. No.: 12/972,437

(22) Filed: Dec. 18, 2010

(51) Int. Cl. A61G 1/00

(52) U.S. Cl. 224/159

(57) ABSTRACT

The standing child carrier is a lightweight carrier fastened to the wearer's shoulders that allows for the child to be carried while the child is in a standing position.

### CROSS-REFERENCE TO RELATED APPLICATIONS

Not Applicable.

### STATEMENT REGARDING FEDERALLY SPONSORED RESEARCH OR DEVELOPMENT

Not Applicable.

### BACKGROUND OF THE INVENTION

The background of the invention will be discussed in two parts.

### FIELD OF THE INVENTION

This invention relates to an apparatus worn by an adult for carrying a child, specifically to carry heavier, older children while the child is in a standing position.

### DESCRIPTION OF THE RELATED ART

Child carriers which permit a user to transport an infant or child either on one's front, back or hip are well known. These carriers typically wrap around a child in a seated position and are designed for children at or below 30 lbs. Older larger children still inevitably want and need to be carried.

A seated position causes the center of gravity of the child to move causing undue stress on the back of the carrier. The optimum position for the center of gravity of a payload is as close the natural center of gravity of the carrier. By keeping the child in a standing position it causes less travel in the center of gravity and allows the center of gravity of the child to remain in close proximity to the center of gravity of the carrier.

Older children's larger legs can get in the way when attempting to carry in a seated position, the standing position allows for a smaller overall cross sectional footprint. Additionally, the seated position can cause reduced blood flow to the legs and feet causing numbness and pain.

Known prior art child carriers include U.S. Pat. No. 3,968,910; U.S. Pat. No. 4,009,808; U.S. Pat. No. 4,037,764; U.S. Pat. No. 4,139,131; U.S. Pat. No. 4,416,403; U.S. Pat. No. 4,487,346; U.S. Pat. No. 4,579,264; U.S. Pat. No. 4,901,898 U.S. Pat. No. 5,441,186; U.S. Pat. No. 5,509,590; U.S. Pat. No. 6,098,857; U.S. Pat. No. 6,186,381; U.S. Pat. No. 6,535,342 U.S. Pat. No. 6,561,394; U.S. Pat. No. 6,575,342; U.S. Pat. No. 6,837,406; U.S. Pat. No. 6,926,181; U.S. Pat. No. 7,322,498; U.S. Pat. No. 7,484,645; U.S. Pat. No. 7,575,136; U.S. Pat. No. 7,686,195;

None of these patents attempt to satisfy the existing need for a child carriers for larger children. Additionally, they all only accommodate a child in the seated or lying position.

In these respects, the Standing Child Carrier according to the present invention substantially departs from the conventional concepts and designs of the prior art, and in so doing provides an apparatus primarily developed for the purpose of transporting a child in a standing position. Thus, allowing the wearer to transport heavier children in a hands-free manner.

### BRIEF SUMMARY OF THE INVENTION

The present invention provides a new Standing Child Carrier wherein the wearer can transport a child in a standing position while maintaining hands-free operation.

To attain this, the present invention comprises of a platform member supported by a strap which hangs from the back of the wearer.

This is further supported by shoulder straps worn by the wearer.

Accordingly, several objects and advantages of my invention are:

(a) The child's weight is distributed over the wearers shoulder which allows for the maximum carrier endurance.

(b) The child will be in a standing position which will allow for good circulation to the legs and feet.

(c) The cross sectional footprint of the wearer and the child is much lower than in a seated position.

(d) The travel of the center of gravity of the child remains constant, hence less stress on the wearer's back.

(e) The wearer can operate in a hands-free manner.

Further objects and advantages of my invention will become apparent from a consideration of the drawings and ensuing description.

### BRIEF DESCRIPTION OF THE SEVERAL VIEWS OF THE DRAWING

FIG. 1 is a side perspective view of the embodiment of the invention fastened to a user's body.

REFERENCE NUMERALS IN DRAWING

| | | | |
|---|---|---|---|
| 10 | step | 12 | rectangular slot |
| 14 | step support strap | 16 | height adjustment strap |
| 18 | standard tri-glide fastener | 20 | standard swivel connector |
| 22 | step notch | 24 | standard swivel snap-hook |
| 26 | standard D-ring | 28 | standard padded shoulder strap |
| 30 | storage pouch | 32 | safety strap |
| 34 | step lip | 36 | step tread |
| 38 | zipper | | |

### DETAILED DESCRIPTION OF THE INVENTION

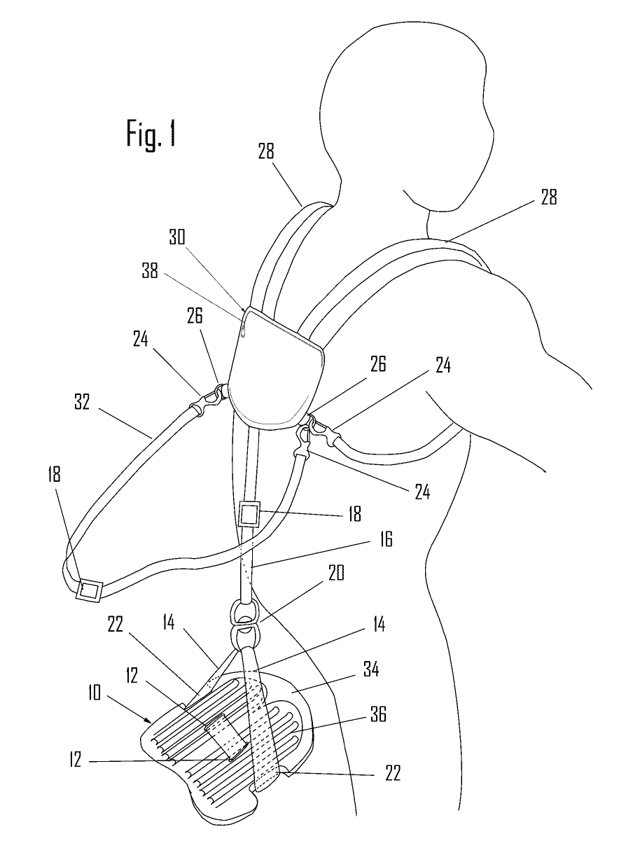

A typical embodiment of the invention is illustrated in FIG. 1. FIG. 1 shows a side perspective view of the basic version of the invention which comprises of a step (10) that a child will stand on. The step (10) is made of durable, lightweight, plastic with suitable injection molded High-density polyethylene (HDPE) or similar material. The step (10) is made of a step lip (34) to funnel water and dirt from shoes away from the user and a step tread (36) to reduce slippage. The step (10) is notched on both sides (22) and contains 2 rectangular slots (12) to allow for a step support strap (14) to weave through. The step support strap (14) which is made of a suitable material such as nylon will be attached to a standard swivel connector (20).

The standard swivel connector (20) will be used to connect the step support strap (14) to an adjustment strap (16) on a perpendicular plane.

A standard tri-glide fastener (18) will be used on the adjustment strap (16) to ensure the proper height for the user. The adjustment strap (16) will be sewn to the self storage pouch (30).

The self storage pouch (30) is made up of a standard zipper and two D-rings (26). The D-rings (26) will be sewn into the self storage pouch (30) which will be the fastening location for both the safety strap (32) and standard padded backpack straps (28).

The safety strap (32) will be used to wrap around the back of the child with an incorporated standard tri-glade fastener (18) for adjustment. The safety strap (32) will be clipped to a standard D-ring (26) with a standard swivel snap-hook (24).

Standard padded backpack shoulder straps (28) will be sewn to the storage pouch (30) at the top and worn over the user's shoulders and then again clipped to the standard D-ring (26) with a standard swivel snap-hook (24).

1. A child carrier comprising of a standing portion.

2. A child carrier comprising of a step or steps as a means of supporting a child in the standing position.
